(19) United States
(12) Patent Application Publication
(10) Pub. No.: US 2012/0278251 A1
(43) Pub. Date: Nov. 1, 2012

(54) SYSTEM AND METHOD FOR COMPLIANT INTEGRATED PAPERLESS WORKFLOW

(76) Inventors: Michael PINSKER, Los Angeles, CA (US); Tom Embrogno, Henderson, NV (US)

(21) Appl. No.: 13/093,845

(22) Filed: Apr. 26, 2011

(51) Int. Cl. G06Q 10/00; G06Q 40/00

(52) U.S. Cl. 705/342

(57) ABSTRACT

A system and method for compliant integrated paperless workflow. Check information corresponding to one or more checks is received from at least one remote scanning module in accordance with one or more financial security standards. Paper form information corresponding to one or more paper forms is received from the least one remote scanning module in accordance with the one or more financial security standards. Electronic form information corresponding to one or more electronic forms is received from in accordance with the one or more financial security standards. The check information, paper form information and electronic form information are securely stored and provided in accordance with the one or more financial security standards.

### BACKGROUND OF THE INVENTION

1. Field of the Invention

Embodiments of the disclosure provided herein pertain to the field of digital workflow systems. More particularly, but not by way of limitation, one or more embodiments of the disclosure set forth herein are directed to a system and method for compliant integrated paperless workflow.

2. Description of the Related Art

Industries and companies have shifted from working with paper-based documents to implementing digital document management systems. The benefits of shifting to digital document management systems include productivity gains, cost savings, and space savings. But in certain industries, such as the financial industries, the shift to digital documents is more problematic. By its very nature, digital data is easily altered or destroyed. Unless proper precautions are taken, digital documents containing financial transaction information could be destroyed or modified in an attempt to conceal unlawful behavior.

The financial industry, which is heavily regulated by both governmental and non-governmental agencies, is expected to benefit from the use of digital document management systems as traditional paper-based compliance policies are becoming increasingly costly. For example, industry studies reveal that the securities industry alone spent in excess of $23 billion on compliance related activities in 2004. These costs to comply with regulations are coming at a time when the financial industry is becoming increasingly competitive.

The Financial Industry Regulatory Authority (“FINRA”) is one such agency that regulates financial institutions. FINRA is the largest non-governmental regulator for all security firms doing business in the United States. It was created in July 2007 as a consolidation of the National Association of Securities Dealers, Inc. (“NASD”) and the member regulation, enforcement, and arbitration functions of the New York Stock Exchange. FINRA oversees nearly 5,000 brokerage firms, about 173,000 branch offices, and 676,000 registered securities representatives.

As part of the oversight procedures, FINRA requires special supervisory practices in place for FINRA members that are designated as an Office of Supervisory Jurisdiction (“OSJ”). An OSJ is an office of a financial institution which executes orders, makes markets, structures public offerings or private placements, maintains custody of customer securities, approves new accounts or sales literature, or supervises other financial advisors.

The key persons charged with implementing these supervisory practices within an OSJ are called the registered principals. FINRA requires the designation of registered principals in each OSJ, including the main office, and one or more appropriately registered principals in each non-OSJ branch office with authority to carry out the supervisory responsibilities assigned to that office.

With respect to digital document management systems, these registered principals have three important responsibilities. First, FINRA requires that the registered principals of the OSJ review all incoming and outgoing written and electronic correspondence of its registered representatives relating to the investment banking or securities business. Second, each financial institution must retain correspondence relating to its investment banking or securities business. Third, the names of the persons who prepared the outgoing correspondence and who reviewed the correspondence must be ascertainable from the retained records. The retained records must be readily available to FINRA.

Member financial institution firms have been known to comply with FINRA rules by employing conventional paper-based systems. In one scenario, financial representatives send client transaction paper documents through the mail or private courier to the registered principal in the OSJ. The registered principal reviews the documents, and then physically stamps and/or signs the document indicating approval or rejection. Financial firms may then electronically scan the paper document to create a digital document. The digital document is then archived.

Financial institutions that follow this approach may therefore prepare, print, handle, and physically transport thousands of documents. This approach is particularly problematic for remote branch offices that do not have a registered principal on-site to process and approve client transaction documents. Furthermore, the process can be costly in terms of labor expended on document preparation and review, as well as in terms of charges for overnight delivery.

Financial service firms are missing certain key technology components in order to make straight through processing a reality in terms integration. Data standards, e-signatures, and electronic check processing are the missing components needed to deliver a completely paperless process. There are no industry standards—save compliance requirements—and the lack of such standards is a contributing factor to the slow acceptance of electronic processing. Moreover, there are only a few clearing houses and product companies accepting electronic feeds today.

Financial institutions that are members of the FINRA face significant repercussions for non-compliance. Member institutions that fail to comply with FINRA rules and regulations face significant fines and penalties and financial representatives face suspension or disbarment.

For at least the limitations described above, there is a need for a system and method for compliant integrated paperless workflow that meets the requirements of government and non-government regulatory agencies.

### BRIEF SUMMARY OF THE INVENTION

One or more embodiments set forth throughout this disclosure are directed to systems and methods for compliant integrated paperless workflow involving integrated, straight-through processing that reduces paper and manual processing, such as in the branch office and home office for all areas of broker dealers operations. The service may be implemented as a distributed, web based system deployed via a Software as a Service (SaaS) model.

Multi-channel capture allows users to scan, upload, and fax documents into the system regardless of format, including both paper and electronic-based documents. Intelligence is embedded into the capture process to reduce steps and improve the integrity of data. Once an item is captured, the workflow system routes the image or work item based on pre determined rules, providing of compliant storage for books and records under regulations. Examples of such regulations include SEC Rules 17a-4 and 17a-3 as well as electronic supervision under FINRA Rules 3110 and 3010.

One or more embodiments of systems and methods for compliant integrated paperless workflow are directed to a computer-readable medium including computer-readable instructions for compliant integrated paperless workflow, where execution of the computer-readable instructions by one or more processors causes the one or more processors to carry out steps.

The steps performed by the one or more processors executing the computer-readable instructions include receiving check information corresponding to one or more checks from at least one remote scanning module in accordance with one or more financial security standards.

The steps performed by the one or more processors executing the computer-readable instructions further include receiving paper form information corresponding to one or more paper forms from the at least one remote scanning module in accordance with the one or more financial security standards.

In one or more embodiments, the at least one remote scanning module is located in at least one field office, where the at least one field office receives and processes the checks and the paper forms in accordance with the one or more financial security standards.

The steps performed by the one or more processors executing the computer-readable instructions further include receiving electronic form information corresponding to one or more electronic forms in accordance with the one or more financial security standards.

The steps performed by the one or more processors executing the computer-readable instructions further include securely storing the check information, the paper form information and the electronic form information in accordance with the one or more financial security standards.

In one or more embodiments, the check information, the paper form information and the electronic form information are securely stored in at least one compliant data store in accordance with the one or more financial security standards.

The steps performed by the one or more processors executing the computer-readable instructions further include providing the check information, the paper form information and the electronic form information in accordance with the one or more financial security standards.

In one or more embodiments of the computer-readable medium including computer-readable instructions for compliant integrated paperless workflow, the steps performed by the one or more processors executing the computer-readable instructions further include accepting at least one modification to the check information, the paper form information and the electronic form information, and securely storing the at least one modification in accordance with the one or more financial security standards. In one or more embodiments, the at least one modification includes at least one of an approval, a review, an audit, a modification, an escalation, a flag, and a rejection.

In one or more embodiments of the computer-readable medium including computer-readable instructions for compliant integrated paperless workflow, the steps performed by the one or more processors executing the computer-readable instructions further include providing the check information to one or more financial service organizations, receiving additional check information from the one or more financial service organizations, and securely storing the additional check information in accordance with the one or more financial security standards. In one or more embodiments, the additional check information is selected from at least one of an approval, a flag, a rejection, a pending status, and a cleared status.

One or more embodiments of systems and methods for compliant integrated paperless workflow are directed to a computer-implemented method for compliant integrated paperless workflow.

The computer-implemented method for compliant integrated paperless workflow includes the step of receiving check information corresponding to one or more checks over a network from at least one remote scanning device in accordance with one or more financial security standards.

The computer-implemented method for compliant integrated paperless workflow further includes the step of receiving paper form information corresponding to one or more paper forms over a network from the at least one remote scanning device in accordance with the one or more financial security standards.

In one or more embodiments, the at least one remote scanning device is located in at least one field office, where the at least one field office receives and processes the checks and the paper forms in accordance with the one or more financial security standards.

The computer-implemented method for compliant integrated paperless workflow further includes the step of receiving electronic form information corresponding to one or more electronic forms over a network in accordance with the one or more financial security standards.

The computer-implemented method for compliant integrated paperless workflow further includes the step of securely storing the check information, the paper form information and the electronic form information in at least one compliant data store in accordance with the one or more financial security standards.

The computer-implemented method for compliant integrated paperless workflow further includes the step of providing the check information, the paper form information and the electronic form information in accordance with the one or more financial security standards.

In one or more embodiments of the computer-implemented method for compliant integrated paperless workflow further includes the steps of accepting at least one modification to the check information, the paper form information and the electronic form information, and securely storing the at least one modification in the at least one compliant data store in accordance with the one or more financial security standards. In one or more embodiments, the at least one modification includes at least one of an approval, a review, an audit, a modification, an escalation, a flag, and a rejection.

In one or more embodiments of the computer-implemented method for compliant integrated paperless workflow further includes the steps of providing the check information to one or more financial service organizations, receiving additional check information from the one or more financial service organizations, and securely storing the additional check information in the at least one compliant data store in accordance with the one or more financial security standards. In one or more embodiments, the additional check information is selected from at least one of an approval, a flag, a rejection, a pending status, and a cleared status.

One or more embodiments of systems and methods for compliant integrated paperless workflow are directed to a system for compliant integrated paperless workflow.

The system for compliant integrated paperless workflow includes at least one processor.

The system for compliant integrated paperless workflow further includes at least one compliant data store configured to securely store and authenticate at least one document in accordance with one or more financial security standards.

The system for compliant integrated paperless workflow further includes a customer relationship management module configured to manage electronic forms and authenticate electronic forms signed electronically in accordance with the one or more financial security standards.

The system for compliant integrated paperless workflow further includes at least one scanning module configured to scan checks and paper forms.

The system for compliant integrated paperless workflow further includes a check processing module configured to securely receive check information corresponding to the checks from the at least one scanning module in accordance with the one or more financial security standards, where the check processing module is further configured to securely communicate with one or more financial service organizations.

In one or more embodiments, the at least one scanning module is located in at least one field office configured to receive at least one of the paper forms and the checks.

The system for compliant integrated paperless workflow further includes a paperless office workflow module configured to securely store and access one or more documents in the at least one compliant data store in accordance with the one or more financial security standards. The paperless office workflow module is further configured to receive paper form information corresponding to the paper forms from the at least one scanning module in accordance with the one or more financial security standards. The paperless office workflow module is further configured to receive electronic form information corresponding to the electronic forms from the customer relationship management module in accordance with the one or more financial security standards.

In one or more embodiments, the compliant data store further includes the check information from the check processing module and other check processing information from the one or more financial service organizations.

In one or more embodiments, the one or more financial security standards include at least one rule set corresponding to a specific regulation. In one or more embodiments, the at least one rule set is selected from a plurality of rule sets corresponding to a plurality of regulations.

One or more embodiments of the system set forth throughout this disclosure are directed to a method and system for digital document approval and authentication.

In one or more embodiments, after a financial transaction takes place between a financial advisor and a customer, the financial advisor scans the paper-based financial transaction documents and stores the digital version of the financial documents in at least one compliant data store, such as a server-side immutable memory that resides on or is available to a central financial institution server.

In one or more embodiments, when the registered principal of an OSJ accesses the central financial institution server, the system prompts the registered principal with a request for a username and password. After the system authenticates the username and password, the registered principal is presented with one or more screens that enable the registered principal to select digital documents that may be flagged as requiring review and approval. The registered principal may select a digital document requiring approval.

The server may present an image of the digital document and may provide a set of tools that enable the registered principal to electronically stamp the digital document thereby acknowledging that the document is accepted or rejected.

In one or more embodiments, once the stamp is applied the server creates a modified digital document by placing an overlay image of an electronic stamp onto the image of the digital document that indicates the review status (e.g., approved or rejected), the date of the approval, and the username of the registered principal.

In one or more embodiments, the modified digital document with the electronic stamp is stored as a separate digital document in at least one compliant data store, such as a server-side immutable memory on the central financial institution server. The modified digital document is subsequently approved, rejected, or otherwise marked as the digital document travels through the financial institution workflow.

Using the system set forth herein an auditor may review the original digital document, the modified digital document, and all of the subsequent digital documents and may be able to see the exact images of the digital documents at each of the approval steps, as well as determine when and who effectuated the approval. Auditors are assured that the original digital document and the modified digital document are authentic because digital documents stored in the immutable memory cannot be altered or deleted.

In one or more embodiments, data is stored in at least one compliant data store, such as a server-side immutable memory. A user on a client computer accessing the server, is prompted for authentication details and the user's identity is authenticated. Upon the authentication of the user's identity, the authenticated user may be presented with one or more tools that enable the authenticated user to locate existing data on the server-side immutable memory.

A representation of the existing data may be presented to the authenticated user on the client computer. The authenticated user may then generate a write request to the server. Examples of a write request include a save command, an edit command, a command to amend, a command to modify, or a command to over write. Rather than allowing the authenticated user to edit the existing data, the server creates new data that may be an exact copy or otherwise authentically represent the existing data.

The authenticated user may then modify the new data and store the new data on the server-side immutable memory. At the end of this process, the server-side memory contains the existing data that was unaffected by the process and the new data that incorporates the existing data with the modifications made by the authenticated user.

In one or more embodiments, the system and method is designed to comply with FINRA's requirements. To achieve this compliance goal the system enables a registered principal to electronically review all incoming and outgoing correspondence from its associated financial advisors. The system also enables the financial institutions to retain correspondence as the financial documents are stored on a server-side immutable memory. Finally, the names of the persons who reviewed the correspondence can be ascertained as the electronic stamp associated with the documents contains the user name of the registered principal.

In one or more embodiments, server computers and server applications may be employed which offer several advantages. The server-side immutable memory acts as a centralized repository. Users across an enterprise may be able to access all of the financial institution's data in one location. Data and code integrity are maintained as upgrades to the applications eliminate the risk that older versions of the application are manipulating data in an incompatible manner. Additionally, security is enhanced as the authentication can be configured so that it does not occur on a potentially insecure client layer. Furthermore, this approach offers lower maintenance costs as the application is generally presented as client-side software served out by a server.

The immutable memory, which provides a mechanism to store data in a way where the state of the data cannot be altered or modified, may come in various forms. For example, immutable memory may be in the form of a Write Once Read Many memory storage (“WORM”) such as a CD, CD-ROM, CD-R, DVD, DVD-R, DVD+R, BD-ROM, BD-R, or an optical disk. The immutable memory may employ a memory media that is capable of being altered, modified, or deleted, but is otherwise protected from subsequent modification through software, logical, or physical means. The system can, for example, make use of a virtual WORM that employs an algorithm in software that monitors the locations in memory in which a first write operation occurred and prohibits a subsequent operation to this data stored at these locations.

In one or more embodiments, users are authenticated through a process of the server comparing the username and the password offered by a user to the username and password originally entered by the user. Authentication can take various forms and may, for example be in the form of an electronic signature created using public and private keys. Authentication may also utilize something such as a unique number that only the authenticated user possesses. Examples of this form of authentication generally include the use of an identity card, a security token, a software token, a phone, a cell phone, a fingerprint, a retinal image, a physical signature, voice recognition, or biometric identifiers. The authentication may be multi-factored in which a combination of methods may be employed so as to add additional layers of security. Examples of a multi-factored authentication include an identification card and a PIN, a digital signature and a challenge-response authentication, or any other combination with two or more authentication methods. Authentication may, for example, be based on cryptography or the OpenID initiative. OpenID is one example of a decentralized digital identity system that is based on a unique URL.

The authenticated user may be presented with a series of search tools to find specific documents or sets of documents that share a common attribute. Examples of various search criteria include document type, form name, document date, compliance status, creation time and date, document ID, document date out, check number, check amount, and number of shares. However, any form of electronically searching for data or documents is in keeping with the spirit of the disclosure provided herein.

In one or more embodiments, the authenticated user is presented with several tools to transform the digital document to be reviewed. Examples of these tools include functions such as create, split, rotate, and sign. The authenticated user is presented in at least one embodiment with the ability to place an electronic stamp reflecting that the digital document is approved, disapproved, or that the authenticated user declines to alter the digital document's approval status. Examples of electronic stamps include electronic watermarks or electronic signatures. Electronic stamps can include various “metadata” such as the date of the review, the username of the authenticated user who reviewed the digital document, a message, routing information, information reflecting a priority status, information reflecting a need to handle the digital document in a particular manner, and the authenticated user's full name. The authenticated user is generally presented with tools to sign specific pages of the digital document or specific ranges within the digital document. Authenticated users may also be able to place the electronic stamp anywhere on the digital document.

Many industries, companies, and individuals can advantageously employ the methods and systems set forth throughout this disclosure. For example, under the Sarbanes-Oxley Act of 2002, many companies are held to a new level of accountability. All U.S. public companies and companies that have securities filed in the United States must implement processes, reports, and systems to demonstrate corporate best practices to investors. Likewise, the Securities and Exchange Commission (“S.E.C.”) requires public companies to store data in immutable media.

Embodiments of systems and methods for compliant integrated paperless workflow can be advantageously used companies affected by the Sarbanes Oxley Act, the S.E.C. requirements, FINRA requirements, and other similar laws and regulations. Furthermore, one or embodiments of the methods and system described in this disclosure may be advantageously employed by small businesses or individuals as a means of processing and storing other documents and data requiring authentication and/or approval.

### BRIEF DESCRIPTION OF THE DRAWINGS

The above and other aspects, features and advantages of the methods and system described herein will be more apparent from the following more particular description thereof, presented in conjunction with the following drawings wherein:

FIG. 1 illustrates an exemplary computer system compatible with one or more embodiments of systems and methods for compliant integrated paperless workflow.

FIG. 2 illustrates a system diagram in accordance with one or more embodiments of systems and methods for compliant integrated paperless workflow.

FIG. 3 is a flowchart of an exemplary process in accordance with one or more embodiments of systems and methods for compliant integrated paperless workflow.

FIG. 4 illustrates an exemplary search tool in accordance with one or more embodiments of systems and methods for compliant integrated paperless workflow.

FIG. 5 illustrates an exemplary list of documents in accordance with one or more embodiments of systems and methods for compliant integrated paperless workflow.

FIG. 6 illustrates an exemplary retrieved digital document and exemplary document modification tools in accordance with one or more embodiments of systems and methods for compliant integrated paperless workflow.

FIG. 7 illustrates exemplary document modification tools in accordance with one or more embodiments of systems and methods for compliant integrated paperless workflow.

FIG. 8 illustrates an exemplary digital document modified with an electronic stamp in accordance with one or more embodiments of systems and methods for compliant integrated paperless workflow.

FIG. 9 is a flowchart of an exemplary process for approving and storing a digital document in accordance with one or more embodiments of systems and methods for compliant integrated paperless workflow.

### DETAILED DESCRIPTION

A system and method for compliant integrated paperless workflow will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. In other instances, specific features, quantities, or measurements well known to those of ordinary skill in the art have not been described in detail so as not to obscure the invention. Readers should note that although examples of the invention are set forth herein, the claims, and the full scope of any equivalents, are what define the metes and bounds of the invention.

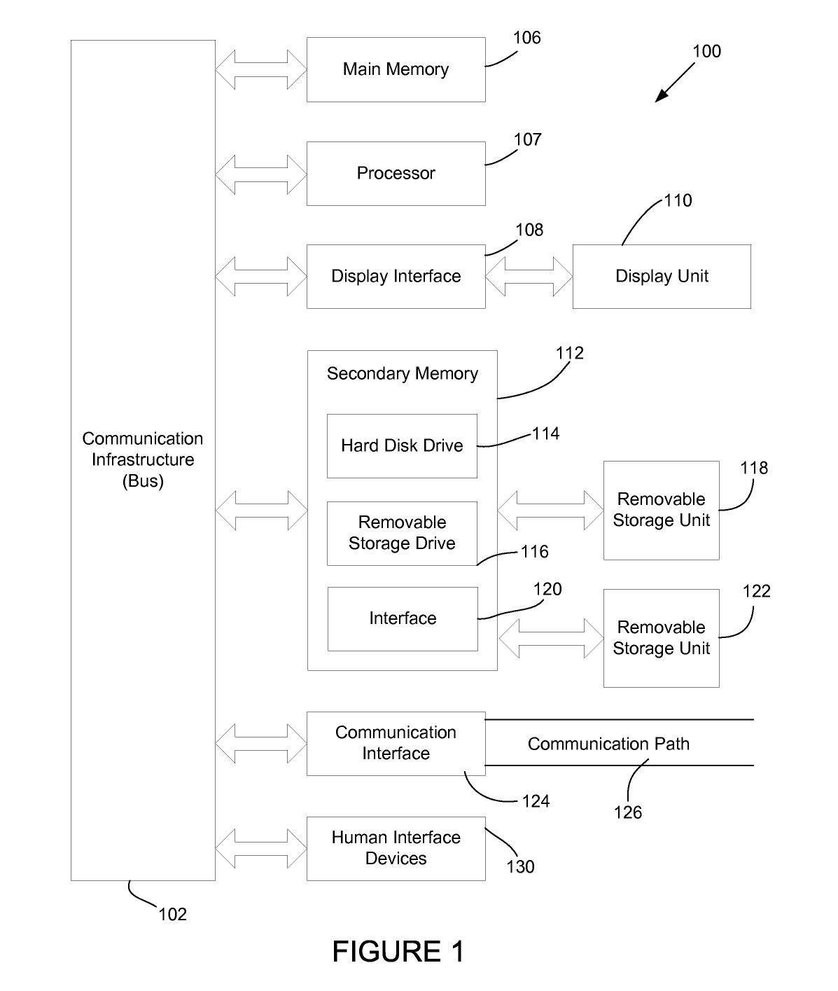

FIG. 1 diagrams a general-purpose computer and peripherals, when programmed as described herein, may operate as a specially programmed computer capable of implementing one or more methods, apparatus and/or systems of the solution described in this disclosure. Processor 107 may be coupled to bi-directional communication infrastructure 102 such as communication infrastructure system bus 102. Communication infrastructure 102 may generally be a system bus that provides an interface to the other components in the general-purpose computer system such as processor 107, main memory 106, display interface 108, secondary memory 112 and/or communication interface 124.

Main memory 106 may provide a computer readable medium for accessing and executed stored data and applications. Display interface 108 may communicate with display unit 110 that may be utilized to display outputs to the user of the specially-programmed computer system. Display unit 110 may include one or more monitors that may visually depict aspects of the computer program to the user. Main memory 106 and display interface 108 may be coupled to communication infrastructure 102, which may serve as the interface point to secondary memory 112 and communication interface 124. Secondary memory 112 may provide additional memory resources beyond main memory 106, and may generally function as a storage location for computer programs to be executed by processor 107. Either fixed or removable computer-readable media may serve as Secondary memory 112. Secondary memory 112 may include, for example, hard disk 114 and removable storage drive 116 that may have an associated removable storage unit 118. There may be multiple sources of secondary memory 112 and systems implementing the solutions described in this disclosure may be configured as needed to support the data storage requirements of the user and the methods described herein. Secondary memory 112 may also include interface 120 that serves as an interface point to additional storage such as removable storage unit 122. Numerous types of data storage devices may serve as repositories for data utilized by the specially programmed computer system. For example, magnetic, optical or magnetic-optical storage systems, or any other available mass storage technology that provides a repository for digital information may be used.

Communication interface 124 may be coupled to communication infrastructure 102 and may serve as a conduit for data destined for or received from communication path 126. A network interface card (NIC) is an example of the type of device that once coupled to communication infrastructure 102 may provide a mechanism for transporting data to communication path 126. Networks may include Local Area Networks (LAN), Wide Area Networks (WAN), Wireless networks, optical networks, telecommunications networks, distributed networks, the Internet or any combination thereof that may be utilized by the specially program computer system. Communication path 126 may include any type of telecommunication network or interconnection fabric that can transport data to and from communication interface 124.

To facilitate user interaction with the specially programmed computer system, one or more human interface devices (HID) 130 may be provided. Some examples of HIDs that enable users to input commands or data to the specially programmed computer may include a keyboard, mouse, touch screen devices, microphones or other audio interface devices, motion sensors or the like, as well as any other device able to accept any kind of human input and in turn communicate that input to processor 107 to trigger one or more responses from the specially programmed computer are within the scope of the system disclosed herein.

While FIG. 1 depicts a physical device, the scope of the system may also encompass a virtual device, virtual machine or simulator embodied in one or more computer programs executing on a computer or computer system and acting or providing a computer system environment compatible with the methods and processes of this disclosure. In one or more embodiments, the system may also encompass a cloud computing system or any other system where shared resources, such as hardware, applications, data, or any other resource are made available on demand over the Internet or any other network. Where a virtual machine, process, device or otherwise performs substantially similarly to that of a physical computer system, such a virtual platform will also fall within the scope of disclosure provided herein, notwithstanding the description herein of a physical system such as that in FIG. 1.

One or more embodiments are configured to enable the specially programmed computer to take the input data given and transform it into a web-based UI by applying one or more of the methods and/or processes described herein. Thus the methods described herein are able to transform a stored component into a web UI, using the solution disclosed here to result in an output of the system as a web UI design support tool, using the specially programmed computer as described herein.

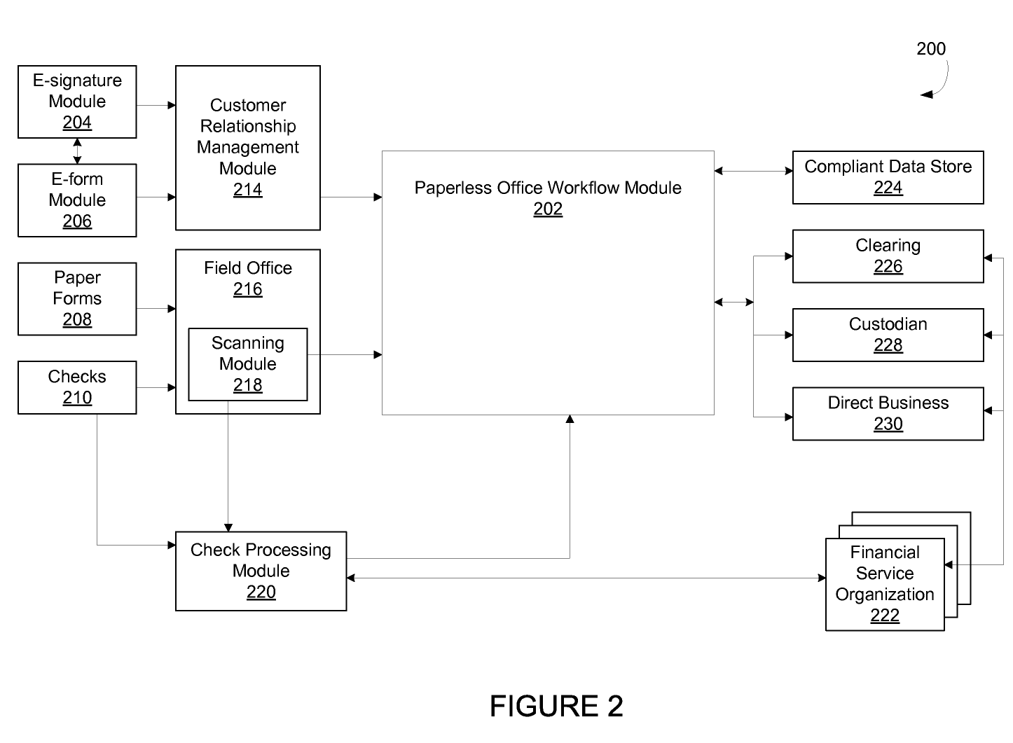

FIG. 2 illustrates a system diagram in accordance with one or more embodiments of systems and methods for compliant integrated paperless workflow.

Compliant integrated paperless workflow system 200 includes at least one compliant data store 224. Compliant data store 224 is configured to securely store and authenticate at least one document in accordance with one or more financial security standards. In one or more embodiments, compliant data store 224 includes server-side immutable memory configured to store one or more unalterable versions of at least one document. Compliant data store 224 may store any document, including check information corresponding to at least one check 210, paper form information corresponding to at least one paper form 208, and electronic form information corresponding to at least one electronic form.

Compliant integrated paperless workflow system 200 further includes customer relationship management module 214. In one or more embodiments, customer relationship management module 214 is configured to manage electronic forms and authenticate electronic forms signed electronically in accordance with one or more financial security standards.

Customer relationship management module 214 may be configured to provide a plurality of electronic forms to customer users. In one more embodiments, customer relationship management module 214 is further configured to allow management of one or more electronic form libraries by at least one administrator user. Customer relationship management module 214 may be provided as a plurality of services implemented as a distributed, web based system deployed via a Software as a Service (SaaS) model.

Compliant integrated paperless workflow system 200 further includes E-form module 206. In one more embodiments, E-form module 206 is configured to allow management of one or more electronic form libraries by at least one administrator user. E-form module 206 may provide one or more fillable forms, including forms configured for self-population of at least one field. E-form module 206 may be provided as a plurality of services implemented as a distributed, web based system deployed via a Software as a Service (SaaS) model, including services compatible with customer relationship management module 214.

Compliant integrated paperless workflow system 200 further includes E-signature module 204. E-signature module 204 is configured to allow one or more customer users to electronically sign at least one form in accordance with one or more financial security standards. E-signature module 204 may be provided as a plurality of services implemented as a distributed, web based system deployed via a Software as a Service (SaaS) model, including services compatible with e-form module 206 and customer relationship management module 214.

Compliant integrated paperless workflow system 200 further includes paperless office workflow module 202. Paperless office workflow module 202 is configured to securely store and access one or more documents in compliant data store 224 in accordance with one or more financial security standards. For example, paperless office workflow module 202 may communicate with compliant data store 224 to store and access check information corresponding to at least one check 210, paper form information corresponding to at least one paper form 208, and electronic form information corresponding to at least one electronic form.

Compliant integrated paperless workflow system 200 further includes at least one scanning module 218 configured to scan checks 210 and paper forms 208 in accordance with one or more financial security standards. In one or more embodiments, at least one scanning module 218 is located in at least one field office 216 configured to receive at least one of paper forms and checks. For example, a field office 216 may receive paper forms and/or checks by mail, in person, or by any other method. In one or more embodiments, authorized personnel at field office 216 are authorized to use scanning module 218 to process paper forms 208 and checks 210 and to send corresponding paper form information and check information to paperless office workflow module 202 and check processing module 220. Scanning module 218 may communicate with paperless office workflow module 202 and check processing module 220 via any method acceptable in accordance with one or more financial security standards, including but not limited to a secured compliant data link and/or network, such as Local Area Networks (LAN), Wide Area Networks (WAN), Wireless networks, optical networks, telecommunications networks, distributed networks, the Internet or any combination thereof.

Compliant integrated paperless workflow system 200 further includes check processing module 220. In one or more embodiments, check processing module 220 is connected to paperless office workflow module 202 via a secured compliant data link and/or network, such as Local Area Networks (LAN), Wide Area Networks (WAN), Wireless networks, optical networks, telecommunications networks, distributed networks, the Internet or any combination thereof. One of ordinary skill in the art will recognize that check processing module 202 may be incorporated with paperless office workflow module 202 without departing from the spirit or scope of the invention.

Check processing module 220 is configured to securely receive check information corresponding to checks 210 from at least one scanning module 218 in accordance with one or more financial security standards. In one or more embodiments, check processing module 220 is further configured to securely communicate with one or more financial service organizations 222. Financial service organizations 222 may include banks, brokerages, or any other financial organizations subject to regulation.

In one or more embodiments, financial service organizations 222 process checks 210 and update at least once a paperless office workflow module 202 and/or check processing module 220 of a check processing status or operation, such as clearing 226, custodian 228, or direct business 230 status or operations. In one or more embodiments, the paperless office workflow module 202 is configured to receive additional check information from one or more financial service organizations 222 and securely store the additional check information in compliant data store 224 in accordance with one or more financial security standards.

Compliant integrated paperless workflow system 200 may operate in accordance with said one or more financial security standards based on one or more rule sets for handling paper forms, checks and electronic documents. A rule set may correspond to a specific regulation. Compliant integrated paperless workflow system 200 may determine at least one rule set that is applicable to a transaction. The at least one rule set may be selected from a plurality of rule sets corresponding to a plurality of regulations. Examples of such regulations include SEC Rules 17a-4 and 17a-3 as well as electronic supervision under FINRA Rules 3110 and 3010, or any other applicable regulation.

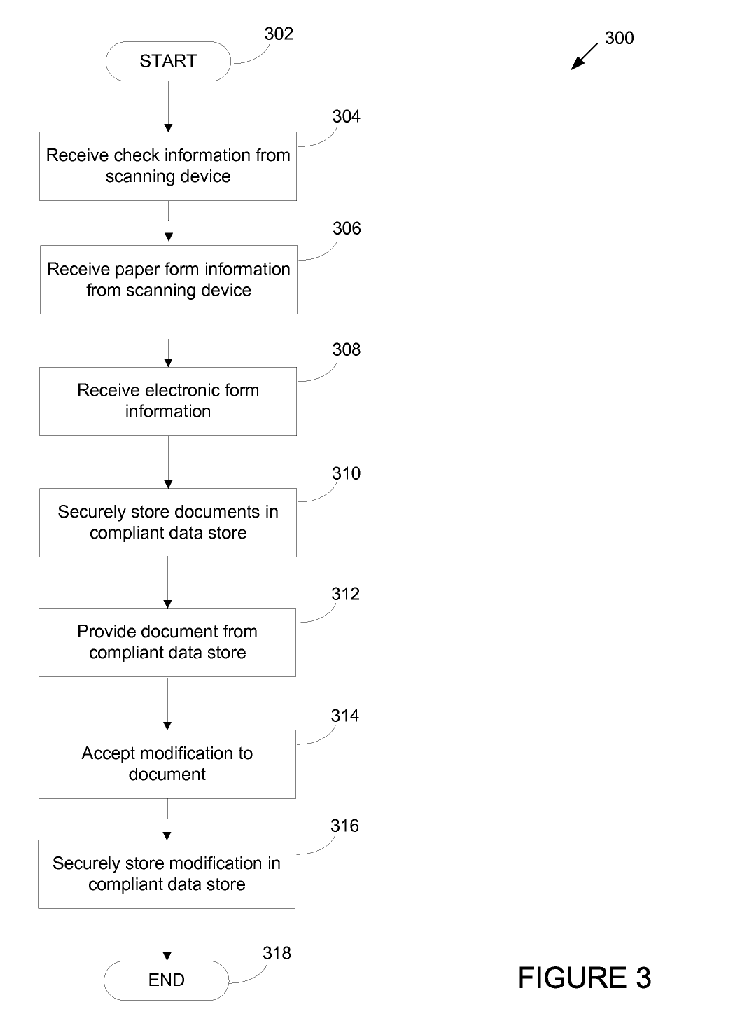

FIG. 3 is a flowchart of an exemplary process in accordance with one or more embodiments of systems and methods for compliant integrated paperless workflow. Process 300 begins at step 302.

Processing continues to step 304, where check information corresponding to one or more checks is received over a network from at least one remote scanning device in accordance with one or more financial security standards. In one or more embodiments, at least one scanning module is located in at least one field office configured to receive at least one of paper forms and checks, such as by mail, in person, or by any other method. The scanning module may be configured to securely communicate with one or more financial service organizations to facilitate check processing.

Processing continues to step 306, where paper form information corresponding to one or more paper forms is received over a network from at least one remote scanning device in accordance with one or more financial security standards. In one or more embodiments, at least one scanning module is located in at least one field office configured to receive at least one of paper forms and checks, such as by mail, in person, or by any other method.

Processing continues to step 308, where electronic form information corresponding to one or more electronic forms is received over a network in accordance with one or more financial security standards. Electronic form information may be received from a customer relationship management module, which may be provided as a plurality of services implemented as a distributed, web based system deployed via a Software as a Service (SaaS) model.

Processing continues to step 310, where documents received are securely stored in at least one compliant data store in accordance with one or more financial security standards. The documents may include check information, paper form information and electronic form information.

Processing continues to step 312, where at least one document is provided from the compliant data store in accordance with one or more financial security standards. The documents may include check information, paper form information and electronic form information. In one or more embodiments, the compliant data store includes server-side immutable memory configured to store one or more unalterable versions of at least one document.

Processing continues to step 314, where at least one modification to a document is accepted. The document may include any document, including check information, paper form information and electronic form information. In one or more embodiments, the modification is selected from at least one modification comprises at least one of an approval, a review, an audit, a modification, an escalation, a flag, a rejection, or any other modification in accordance with one or more financial security standards.

Processing continues to step 316, where the at least one modification is stored in at least one compliant data store in accordance with one or more financial security standards. The at least one modification may be stored as a separate file corresponding to the document, and/or as a single merged or combined file including both the document and the modification.

Processing continues to step 318, where process 300 terminates.

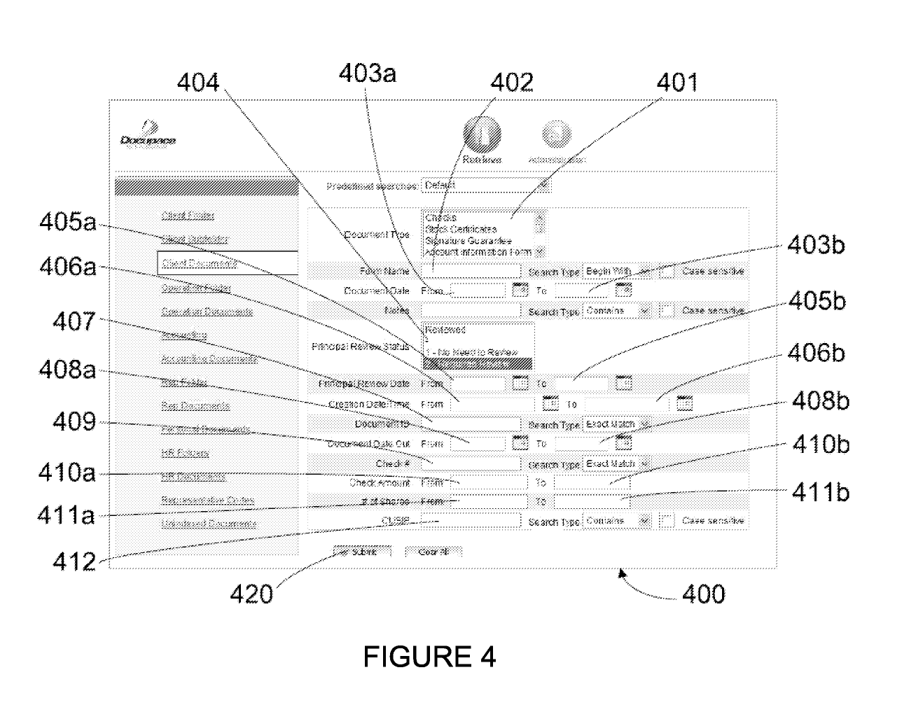

FIG. 4 illustrates an exemplary search tool in accordance with one or more embodiments of systems and methods for compliant integrated paperless workflow.

An authenticated user may be presented with screen view 400 after the user has been properly authenticated. Screen view 400 offers several search tools to enable the authenticated user to retrieve one or more documents that match the search criteria of the authenticated user. For example, Document Type field 401 enables the authenticated user to search for documents based on document type. Based on the entry in Document Type field 401, the server computer searches the compliant data store and presents a list of documents which match the search criteria of the authenticated user.

Other search tools can also be employed. Form Name field 402 enables the authenticated user to enter the name of digital document the authenticated user wishes to retrieve. Documents which have a similar or exact form name may be retrieved from the compliant data store and may be presented in list for review to the authenticated user on a client computer.

Document Date fields 403a and 403b enable the authenticated user to search for documents based on the dates of the digital document. Document Date field 403a enables the authenticated user to enter the earliest date of the digital document and 403b enables the authenticated user to enter the latest date of the digital document. When this tool is employed, a server computer may search the compliant data store for documents dated within the range entered for Document Date fields 403a and 403b and present a list of results to the authenticated user on a client computer.

Principal Review Status field 404 enables the authenticated user to search for documents based on their review status. A server computer searches the compliant data store and presents a list of results of documents that have the selected principal review status to the authenticated user on a client computer. Principal Review Date fields 405a and 405b enable the authenticated user to search for documents based on the date of the principal review. A server computer searches the compliant data store and retrieves a list of documents which were reviewed within the range of dates entered in Principal Review Date field 405a and 405b.

Creation Date fields 406a and 406b enable an authenticated user to search for documents based on the creation date. The authenticated user enters the earliest and latest dates of creation as the search criteria in Creation Date fields 406a and 406b. A server computer searches the compliant data store and retrieves a list of documents which were created within the range of dates entered in Creation Date fields 406a and 406b. Document ID field 407 enables an authenticated user to search for documents based on their document identification values. A server computer searches the compliant data store and presents a list of documents which have a matching or similar digital document identification of the value entered in Document ID field 407.

Document Date Out fields 408a and 408b enables an authenticated user to search for documents based on the date that they were sent out. A server computer searches the compliant data store and presents a list of documents that were sent out within the range of dates entered in Document Date Out fields 408a and 408b. Check Number field 409 enables an authenticated user to search for documents based on the value of the check number. A server computer searches the compliant data store and presents a list of documents that have a similar or matching value as the authenticated user entered in Check Number field 409.

Check Amount fields 410a and 410b enable the authenticated user to search for documents within a range of check amount based on values entered in Check Amount fields 410a and 410b. A server computer searches the compliant data store and presents a list of documents which may be associated with the check amount that fall within the range of values the authenticated user entered in Check Amount fields 410a and 410b. Number of Shares fields 411a and 411b enable the authenticated user to search for documents which may be within a range of the number of shares entered in Number of Shares fields 411a and 411b. A server computer searches the compliant data store and presents a list of documents which have a value of the number of shares within the range entered by the authenticated user in Number of Shares fields 411a and 411b.

Authenticated users may use the search tools to search for documents using an alphanumeric security identifier associated with the Committee on Uniform Security Identification Procedures (“CUSIP”). CUSIP field 412 enables the authenticated user to search for documents based on the CUSIP security identifier. A server computer searches the compliant data store and presents a list of documents that have matching or similar CUSIP values.

Once an authenticated user defines a search using one or more of the search criteria tools, the authenticated user may click Submit button 420. Upon clicking Submit button 420, a client computer may send a message to a server computer via a secured compliant data link and/or network, such as Local Area Networks (LAN), Wide Area Networks (WAN), Wireless networks, optical networks, telecommunications networks, distributed networks, the Internet or any combination thereof. A server computer may receive this message, interprets the message, and then searches the compliant data store which may be accessed. Upon one or iterations of the search, a server computer may create a new webpage which presents a list of the search results. This webpage may be sent to a client computer via data a data link and/or network. A client computer receives the webpage and displays the list of documents to the authenticated user.

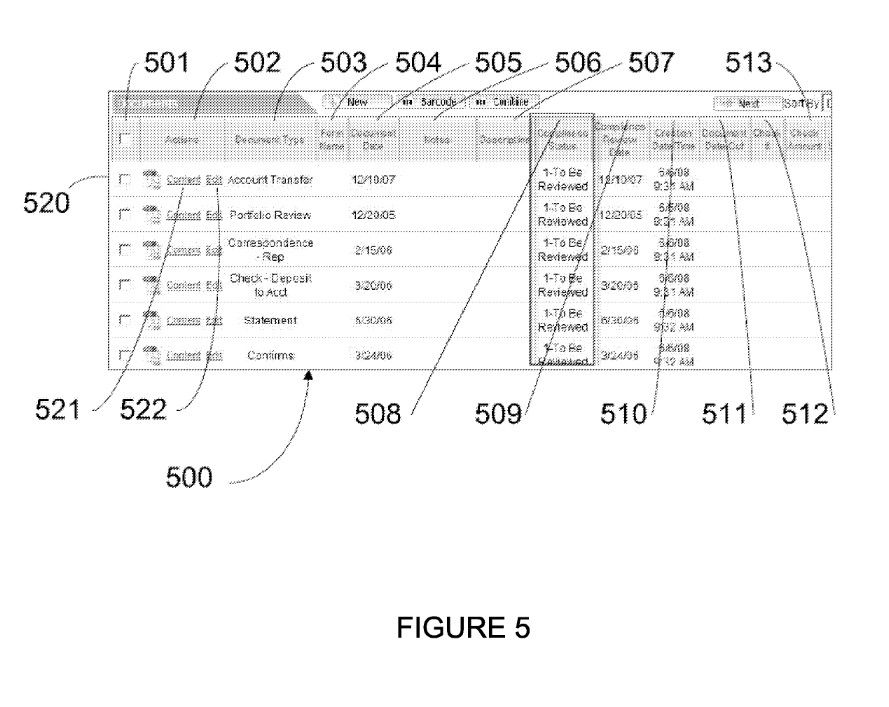

FIG. 5 illustrates an exemplary list of documents in accordance with one or more embodiments of systems and methods for compliant integrated paperless workflow. Window 500 displays a list of digital documents that may be generated in response to search criteria. A plurality of columns may be presented that categorizes information related to the documents identified in the search. Example columns include Select column 501, Actions column 502, Document Type column 503, Form Name column 504, Document Date column 505, Description column 506, Description column 507, Compliance Status column 508, Compliance Review column 509, Creation Date column 510, Document Date Out column 511, Check Number column 512, and Check Amount column 513.

Row 520 represents one digital document that was identified through the search of the compliant data store. The digital document associated with row 520 has a Actions of Content hyperlink 521 and Edit hyperlink, Document Type of “Account Transfer,” a Document Date of “12/10/07,” a Compliance Status of “1—To Be Reviewed,” a Compliance Review Date of “12/10/07,” and a Creation Date/Time of “6/6/08 9:31 AM.”

Once the authenticated user identifies that the digital document associated with row 520 needs review, the authenticated user may click on Edit hyperlink 522. A client computer may then sends a message to a server computer via a secured compliant data link and/or network, such as Local Area Networks (LAN), Wide Area Networks (WAN), Wireless networks, optical networks, telecommunications networks, distributed networks, the Internet or any combination thereof. A server computer may then send a message to the compliant data store. Server side immutable memory may then send information related to the digital document request to a server computer.

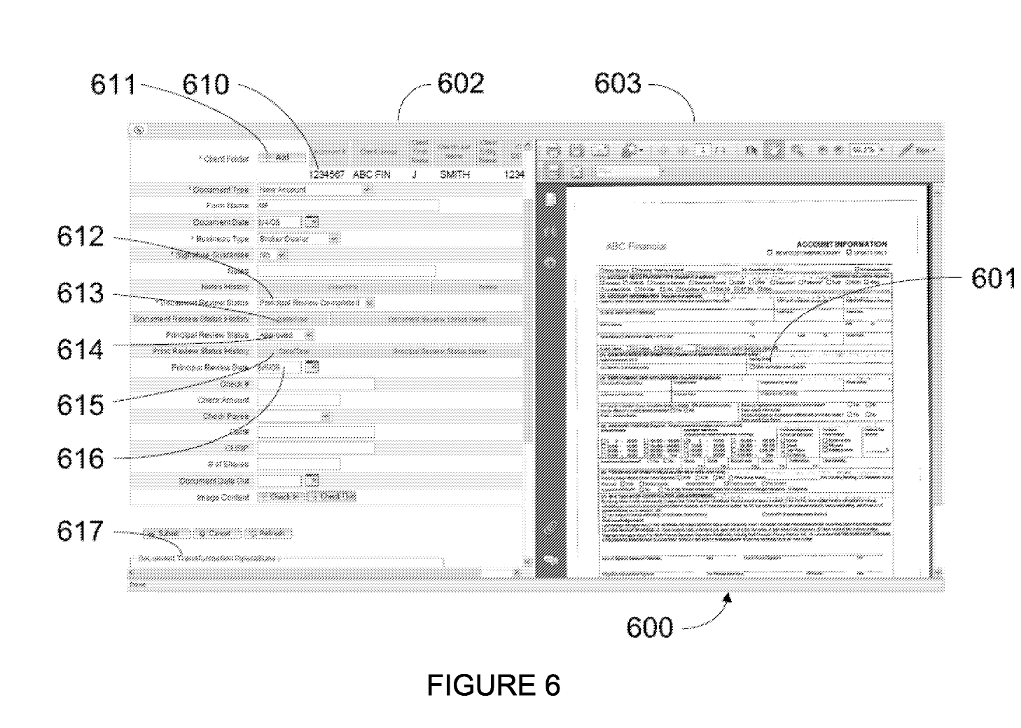

FIG. 6 illustrates an exemplary retrieved digital document and exemplary document modification tools in accordance with one or more embodiments of systems and methods for compliant integrated paperless workflow. Window 600 may be presented to the authenticated user on a client computer. Tools pane 602 may be on the right hand side of window 600, and image pane 603 may be on the left hand side of window 600. Image pane 603 presents the digital document image 601 and a set of digital document tools 605 and image tools 604. Digital document image 601 may be an image of the retrieved digital document.

Tools pane 602 holds a plurality of fields that describe digital document image 601. Field 610 presents information that describes digital document image 601 including the account number, the name of the client group, the client first name, the client last name, and the client entity name. When an authenticated user clicks on client folder button 611, the authenticated user may be enabled to enter indexing fields that describe the location of the digital document within the compliant data store. Document Review Status drop down list 612 enables the authenticated user to select the element from the list that describes the status of the digital document review. For example, the authenticated user may select the element to reflect that the principal review has been completed. The authenticated user may select the element to reflect that the digital document was preliminarily approved by someone other than a registered principal.

Document Review History field 613 enables the authenticated user to see the date, the time, and the name of the digital document review status. Principal Review Status field 614 enables the authenticated user to select whether the digital document was reviewed by a registered principal. Principle Review Status History field 615 presents the authenticated user with the ability to see the date, the time, and name of the principal review status. Principal Review Date field 616 allows the authenticated user to select the date on which the digital document was reviewed by a registered principal.

The authenticated users may edit the contents of digital document image 601. For example, an authenticated user may click on a location of digital document image 601 and allow entry of text at that location. The authenticated user may click or right-click the image to provide the location and contents of an electronic stamp. Other examples of indicia of approval status may include attaching data to the digital document image 601, providing a hyperlink to a location on digital document image 601, providing a bar code to a location on digital document image 601, highlighting a section of digital document image 601, or changing the color of the font or background of digital document image 601.

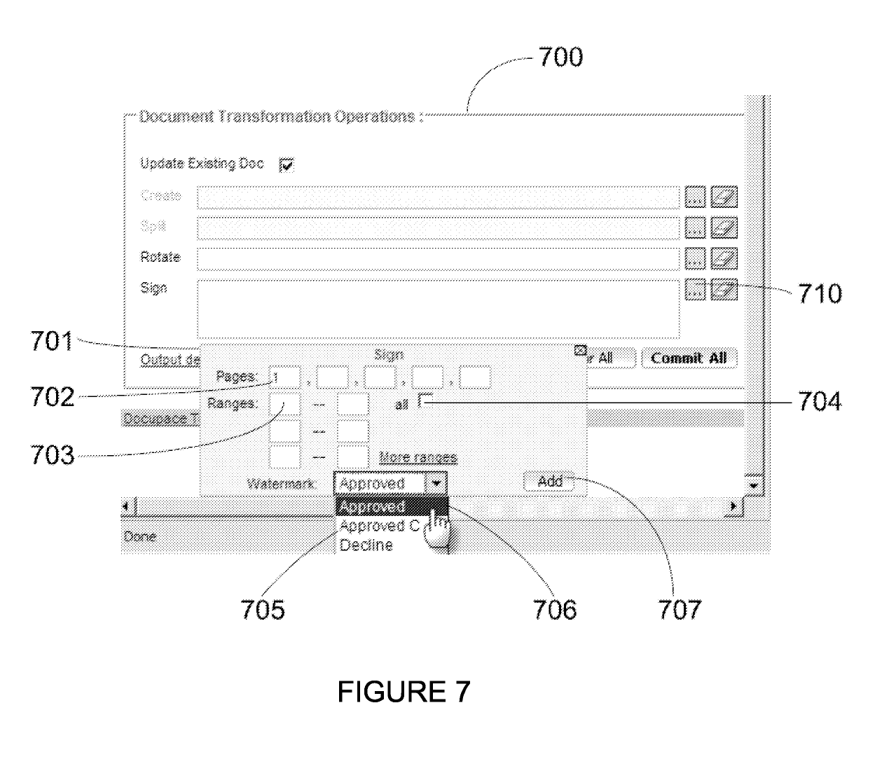

FIG. 7 illustrates exemplary document modification tools in accordance with one or more embodiments of systems and methods for compliant integrated paperless workflow. When an authenticated user activates the Sign field 710, pop up window 701 appears. Entering values in the page block 702 or range block 703 enables the authenticated user to designate the page or the range they wish to provide approval status. All block 704 enables the authenticated user to designate the entire digital document for approval status. Authenticated users may then be able to select the type of electronic stamps from types drop-down list 705, which shows, as an example, the designations of “Approved,” Approved C,” and “Decline.” For example, selected electronic stamp 706 may be selected and the authenticated user clicks on Add button 707. When the authenticated user clicks on Add button 707, a client computer sends a write request to a server computer. Server computer may then create a new digital document within the compliant data store which is an exact copy of the original digital document presented with the modification of an electronic stamp. A server computer may then send data representing the modified digital document image to a client computer where it may be presented to the authenticated user.

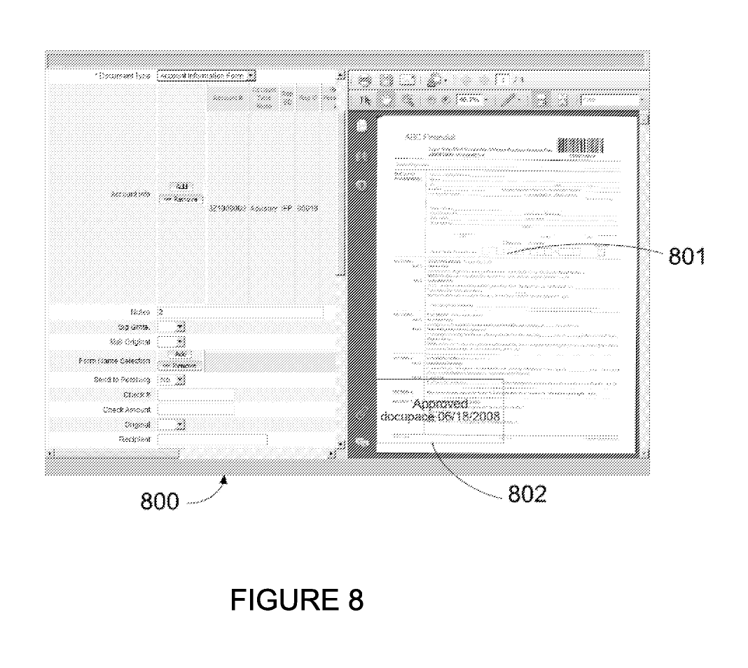

FIG. 8 illustrates an exemplary digital document modified with an electronic stamp in accordance with one or more embodiments of systems and methods for compliant integrated paperless workflow. Window 800 illustrates a representation of the response from a server computer. Document image 801 represents an example of a digital document with the overlay of an electronic stamp image 802 indicating approval, date of approval (“06/18/2008”), and the user that approved the document (“docupace”).

The authenticated user may be presented with the ability to place an electronic stamp image 802 reflecting that the digital document is approved, disapproved, or that the authenticated user declines to pass judgment on the approval status. Electronic stamp image 802 may also display information placed in the form of an electronic stamp include the date of the review, the username of the authenticated user who reviewed the digital document, a message, routing information, information reflecting a priority status, information reflecting a need to handle the digital document in a particular manner, and the authenticated user's full name. Authenticated users may be also enabled to place the electronic stamp image 802 anywhere on the digital document.

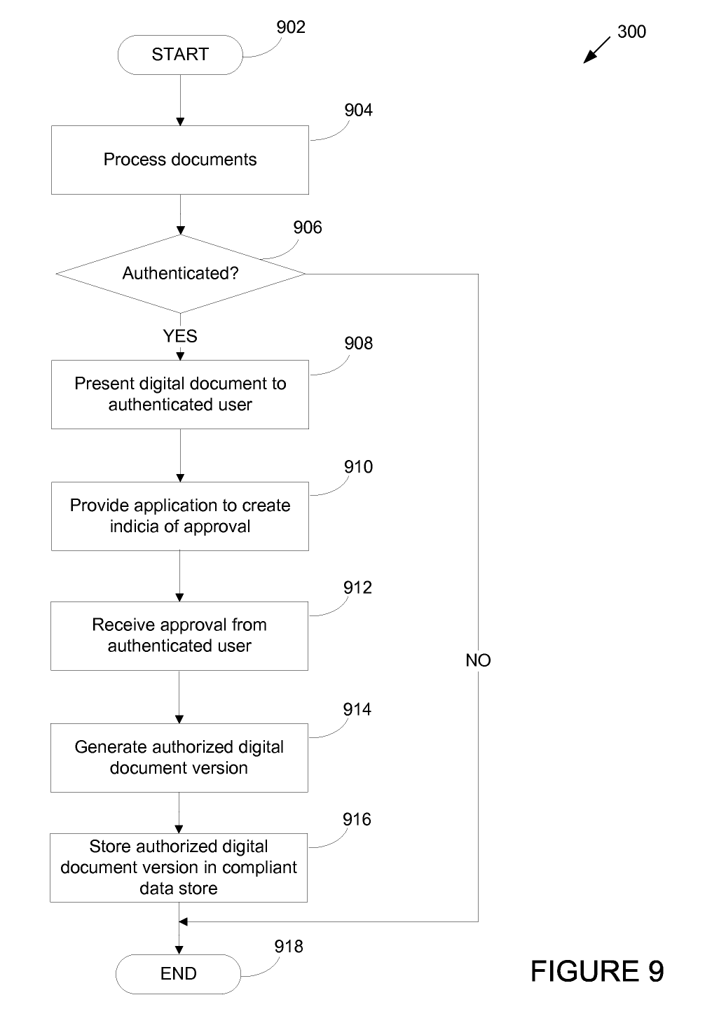

FIG. 9 is a flowchart of an exemplary process for approving and storing a digital document in accordance with one or more embodiments of systems and methods for compliant integrated paperless workflow. Process 900 shows an exemplary modification of a document stored in the compliant data store in accordance with one or more embodiments of systems and methods for compliant integrated paperless workflow. Process 900 starts at step 902.

Processing continues to step 904, where documents are processed. For example, documents may be processed and stored in a compliant data store in accordance with one or more embodiments of the process shown in FIG. 3 for handling documents in accordance with one or more financial security standards, such as check information, paper form information in electronic form information.

Processing continues to decision step 906, where it is determined whether a user attempting to access documents stored in the compliant data store is authenticated. For example, the user may be authenticated through the process of a server computer comparing the username and the password offered by a user to the username and password previously entered by the user. Authentication may be in the form of an electronic signature using public and private keys. The user may also be authenticated by a client computer or through a third party. If one or more embodiments, authentication requires the user to present some object or some biometric identifier to a client computer. Examples of this approach may include the use of an identity card, a security token, a software token, a phone, a cell phone, a fingerprint, a retinal image, a physical signature, a voice, or a biometric identifier. The authentication may be multi-factored in which a combination of methods may be employed. Examples of a multi-factored authentication include an identification card and a personal identification number (“PIN”), a digital signature and a challenge-response authentication, or any other combination with two or more methods. Authentication may be based on cryptography or may be based upon the OpenID initiative. OpenID is one example of a decentralized digital identity system that is based on a unique URL. If the user is not successfully authenticated, process 900 continues to step 918, where process 900 terminates.

Otherwise, processing continues to step 908, where a digital document is presented to an authenticated user for modification. In one or more embodiments, the digital document corresponds to a check, a paper form, or an electronic form, where corresponding check information, paper form information and/or electronic form information is stored in the compliant data store. In one or more embodiments, the modification is selected from at least one modification comprises at least one of an approval, a review, an audit, a modification, an escalation, a flag, a rejection, or any other modification in accordance with one or more financial security standards. Process 900 shows an exemplary modification in the form of an approval of the document by the authenticated user. One of ordinary skill in the art would appreciate that any other modification may be made without departing from the spirit or the scope of the invention.

Processing continues to step 910, where an application is provided for creating an indicia of approval. The application may include any software capable of modifying the document, including any service in a web-based system deployed via a Software as a Service (SaaS) model. The indicia approval may include any data capable of communicating an approval by the authenticated user in accordance with one or more financial security standards. In one or more embodiments, the authenticated user is presented with tools to sign specific pages of the digital document or specific ranges within the digital document.

Processing continues to step 912, where the approval from the authenticated user is received. In one or more embodiments, an electronic stamp is generated that indicates a status (e.g., approved/declined) of the digital document by the authenticated user. The digital signature of the authenticated user is generally obtained from the authenticated user through a digital signature pad but it is feasible to also make use of other electronic signature means. Once the signature is provided the digital signature then becomes part of the electronic stamp. The authenticated user can then be presented with the ability to place an electronic stamp onto the digital document reflecting that the digital document is approved, disapproved, or that the authenticated user declines to alter the approval status.

Examples of electronic stamps include electronic watermarks or electronic signatures. Other examples of the information placed in the form of an electronic stamp include the date of the review, the username of the authenticated user who reviewed the digital document, a message, routing information, information reflecting a priority status, information reflecting a need to handle the digital document in a particular manner, and the authenticated user's full name. The date of review may be generated automatically with the creation of the electronic stamp.

Processing continues to step 914, where an authorized digital document version indicating approval by the authenticated user is generated in accordance with one or more financial security standards. In one or more embodiments, the modified digital document is a combination of the digital document and the electronic stamp. The authorized digital document version may emulate a paper authorization of the paper form, such as by applying an electronic stamp indicating a status, such as approval or disapproval. For example, the electronic stamp may be a digitally generated stamp image positioned on the digital document. The stamp image may be positioned by a user or automatically positioned, such as to take into account one or more factors, such as the size, the orientation, the color, or any other characteristic of the electronic stamp and/or the digital document. The authorized digital document version may be generated as two or more separate files corresponding to the digital document and the electronic stamp. The authorized digital document may also be generated as a single merged or combined file.

Processing continues to step 916, where the authorized digital document version is stored in the compliant data store in accordance with one or more financial security standards. In one or more embodiments, the compliant data store is server-side immutable memory configured to immutably store all versions of the digital document in accordance with one or more financial security standards. The authorized digital document version may be stored in various formats as needed, such as Portable Data Format (“pdf”), Tagged Image File Format (“tif” or “tiff”), or any other document format. The authorized digital document version may be stored in the form of two or more separate files corresponding to the digital document and the electronic stamp. The authorized digital document may also be stored as a single merged or combined file.

Processing continues to step 918, where process 900 terminates.

While the invention herein disclosed has been described by means of specific embodiments and applications thereof, numerous modifications and variations could be made thereto by those skilled in the art without departing from the scope of the invention set forth in the claims.

What is claimed is:

1. A computer-readable medium comprising computer-readable instructions for compliant integrated paperless workflow, wherein execution of said computer-readable instructions by one or more processors causes said one or more processors to carry out steps comprising:
receiving check information corresponding to one or more checks from at least one remote scanning module in accordance with one or more financial security standards;
receiving paper form information corresponding to one or more paper forms from said at least one remote scanning module in accordance with said one or more financial security standards;
receiving electronic form information corresponding to one or more electronic forms in accordance with said one or more financial security standards;
securely storing said check information, said paper form information and said electronic form information in accordance with said one or more financial security standards; and
providing said check information, said paper form information and said electronic form information in accordance with said one or more financial security standards.

2. The computer-readable medium of claim 1, wherein said at least one remote scanning module is located in at least one field office, wherein said at least one field office receives and processes said checks and said paper forms in accordance with said one or more financial security standards.

3. The computer-readable medium of claim 1, wherein said check information, said paper form information and said electronic form information are securely stored in at least one compliant data store in accordance with said one or more financial security standards.

4. The computer-readable medium of claim 1, wherein said computer-readable instructions further comprise:
accepting at least one modification to said check information, said paper form information and said electronic form information; and
securely storing said at least one modification in accordance with said one or more financial security standards.

5. The computer-readable medium of claim 4, wherein said at least one modification comprises at least one of an approval, a review, an audit, a modification, an escalation, a flag, and a rejection.

6. The computer-readable medium of claim 1, wherein said computer readable instructions further comprise:
providing said check information to one or more financial service organizations;
receiving additional check information from said one or more financial service organizations; and
securely storing said additional check information in accordance with said one or more financial security standards.

7. The computer-readable medium of claim 6, wherein said additional check information is selected from at least one of an approval, a flag, a rejection, a pending status, and a cleared status.

8. A computer-implemented method for compliant integrated paperless workflow comprising the steps of:
receiving check information corresponding to one or more checks over a network from at least one remote scanning device in accordance with one or more financial security standards;
receiving paper form information corresponding to one or more paper forms over a network from said at least one remote scanning device in accordance with said one or more financial security standards;
receiving electronic form information corresponding to one or more electronic forms over a network in accordance with said one or more financial security standards;
securely storing said check information, said paper form information and said electronic form information in at least one compliant data store in accordance with said one or more financial security standards; and
providing said check information, said paper form information and said electronic form information in accordance with said one or more financial security standards.

9. The computer-implemented method of claim 8, wherein said at least one remote scanning device is located in at least one field office, wherein said at least one field office receives and processes said checks and said paper forms in accordance with said one or more financial security standards.

10. The computer-implemented method of claim 8, further comprising the steps of:
accepting at least one modification to said check information, said paper form information and said electronic form information; and
securely storing said at least one modification in said at least one compliant data store in accordance with said one or more financial security standards.

11. The computer-implemented method of claim 10, wherein said at least one modification comprises at least one of an approval, a review, an audit, a modification, an escalation, a flag, and a rejection.

12. The computer-implemented method of claim 8, further comprising the steps of:
providing said check information to one or more financial service organizations;
receiving additional check information from said one or more financial service organizations; and
securely storing said additional check information in said at least one compliant data store in accordance with said one or more financial security standards.

13. The computer-implemented method of claim 12, wherein said additional check information is selected from at least one of an approval, a flag, a rejection, a pending status, and a cleared status.

14. A system for compliant integrated paperless workflow comprising:
at least one processor;
at least one compliant data store configured to securely store and authenticate at least one document in accordance with one or more financial security standards;
a customer relationship management module configured to manage electronic forms and authenticate electronic forms signed electronically in accordance with said one or more financial security standards;
at least one scanning module configured to scan checks and paper forms;
a check processing module configured to securely receive check information corresponding to said checks from said at least one scanning module in accordance with said one or more financial security standards, wherein said check processing module is further configured to securely communicate with one or more financial service organizations; and
a paperless office workflow module configured to securely store and access one or more documents in said at least one compliant data store in accordance with said one or more financial security standards, wherein said paperless office workflow module is further configured to receive paper form information corresponding to said paper forms from said at least one scanning module in accordance with said one or more financial security standards, wherein said paperless office workflow module is further configured to receive electronic form information corresponding to said electronic forms from said customer relationship management module in accordance with said one or more financial security standards.

15. The system for compliant integrated paperless workflow of claim 14, wherein said at least one scanning module is located in at least one field office configured to receive at least one of said paper forms and said checks.

16. The system for compliant integrated paperless workflow of claim 14, wherein said compliant data store further comprises said check information from said check processing module and other check processing information from said one or more financial service organizations.

17. The system for compliant integrated paperless workflow of claim 14, wherein said one or more financial security standards comprise at least one rule set corresponding to a specific regulation.

18. The system for compliant integrated paperless workflow of claim 14, wherein said at least one rule set is selected from a plurality of rule sets corresponding to a plurality of regulations.
